(19) United States
(12) Patent Application Publication
(10) Pub. No.: US 2026/0290735 A1
(43) Pub. Date: Sep. 24, 2026

(54) MAIN CIRCUIT BREAKER WITH INTEGRATED REPLACEABLE SURGE PROTECTION

(71) Applicant: EATON INTELLIGENT POWER LIMITED, DUBLIN 4 (IE)

(72) Inventor: Michael J. Whipple, Rochester, PA (US)

(73) Assignee: EATON INTELLIGENT POWER LIMITED, DUBLIN 4 (IE)

(21) Appl. No.: 19/557,651

(22) Filed: Mar. 5, 2026

Related U.S. Application Data
(60) Provisional application No. 63/773,677, filed on Mar. 18, 2025.

(51) Int. Cl. H01H 89/00; H01H 71/04

(52) U.S. Cl. CPC H01H 89/00; H01H 71/04

(57) ABSTRACT

A main circuit breaker with integrated surge protection eliminates the need to wire and install surge protection separately from the main circuit breaker at a service entrance, and additionally eliminates the need to install an individual surge protection scheme for each individual sub-feed connected to the main circuit breaker. The breaker includes a number of replaceable surge protection modules, one for each line voltage, and a module status indicator for each surge protection module to indicate the remaining useful life of the module. The breaker housing is formed with a module receiving opening for each surge protection module. Each module receiving opening and each surge protection module are designed to enable a user to insert the surge protection module into the module receiving opening and remove the surge protection module from the module receiving opening without external tools and using only finger strength.

### CROSS REFERENCE TO RELATED APPLICATIONS

This application claims priority to U.S. Provisional Patent Application Serial No. 63/773677, filed on Mar. 18, 2025 and titled “MAIN CIRCUIT BREAKER WITH INTEGRATED REPLACEABLE SURGE PROTECTION”, the disclosure of which is incorporated herein by reference.

### FIELD OF THE INVENTION

The disclosed concept relates generally to power distribution systems, and in particular, to surge protection for power distribution systems.

### BACKGROUND OF THE INVENTION

Article 230.67 introduced in the 2020 NEC (National Electric Code) requires all services supplying dwelling units to be provided with a surge-protective device (SPD). In traditional residential power distribution systems, providing surge protection at the load center requires additional installation and wiring that is separate from the main circuit breaker, and dedicated surge protection has to be installed for each individual sub-feed. As such, any time the surge protection device or scheme for any individual sub-feed reaches the end of its useful life, said device or scheme has to be de-wired and uninstalled, and a replacement surge protection device or scheme has to be wired and installed in its place.

The present invention thus provides an improved surge protection solution for service entrance main circuit breakers.

### SUMMARY OF THE INVENTION

These needs, and others, are met by embodiments of a main circuit breaker with integrated surge protection structured to be installed at a service entrance, which eliminates the need to wire and install surge protection separately from the main circuit breaker and additionally eliminates the need to install an individual surge protection scheme for each individual sub-feed connected to the main circuit breaker. The breaker includes a number of replaceable surge protection modules, one for each line voltage, and a module status indicator for each surge protection module to indicate the remaining useful life of the module. For each line voltage path, the surge protection module connected to that path provides surge protection to all sub-feeds connected to the load side of the path. The breaker housing is formed with a module receiving opening for each surge protection module. Each module receiving opening and each surge protection module are designed to enable a user to insert the surge protection module into the module receiving opening and remove the surge protection module from the module receiving opening without external tools and using only finger strength.

In accordance with one aspect of the disclosed concept, a main circuit breaker structured to be connected to a service entrance comprises: a main housing; a main bus having a line side and a load side, the main bus being housed within the main housing; a number of voltage connections extending between the line side and the load side; a surge diversion arrangement and a surge protection module for each voltage connection; and a ground wire. For each voltage connection, the surge diversion arrangement electrically connects the load side to the surge protection module. Each surge protection module is electrically connected between the load side and the ground wire, and each surge protection module is coupled to the main housing.

### BRIEF DESCRIPTION OF THE DRAWINGS

A full understanding of the invention can be gained from the following description of the preferred embodiments when read in conjunction with the accompanying drawings in which:

FIG. 1A is an isometric side view of an improved main circuit breaker with integrated surge protection for a residential power distribution system, in accordance with an example embodiment of the disclosed concept;

FIG. 1B is another isometric side view of the improved main circuit breaker shown in FIG. 1A, rotated from the view shown in FIG. 1A;

FIG. 2A is an isometric view of a surge diversion arrangement of the improved main circuit breaker of FIGS. 1A-B;

FIG. 2B shows the same isometric view of the surge diversion arrangement shown in FIG. 2A, with a printed circuit board assembly (PCBA) of the improved main circuit breaker additionally shown;

FIG. 3A is another isometric view of the surge diversion arrangement of FIG. 2A, rotated from the perspective shown in FIG. 2A;

FIG. 3B is another isometric view of the surge diversion arrangement and PCBA shown in FIG. 2B, rotated from the perspective shown in FIG. 2B;

FIG. 4 is an exploded view of the surge diversion arrangement shown in FIGS. 2A-3B;

FIG. 5A is an isometric view of the exterior of the surge bus housing;

FIG. 5B is an isometric view of the interior of the surge bus housing;

FIG. 5C is an exploded isometric view of the surge bus housing;

FIG. 6 is a front elevation view of the improved main circuit breaker shown in FIGS. 1A-1B;

FIG. 7 is a front elevation front view of the improved main circuit breaker of FIGS. 1A-1B installed in a weather-safe enclosure;

FIG. 8 is an enlarged view of a portion of the front of the main housing of the improved main circuit breaker of FIGS. 1A-1B, showing the surge protection modules being positioned for insertion into the main housing; and

FIG. 9 is another enlarged view of a portion of the front of the main housing of the improved main circuit breaker of FIGS. 1A-1B, showing the surge protection modules being positioned for insertion into the main housing, rotated from the perspective shown in FIG. 8.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As used herein, the singular form of “a”, “an”, and “the” include plural references unless the context clearly dictates otherwise.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

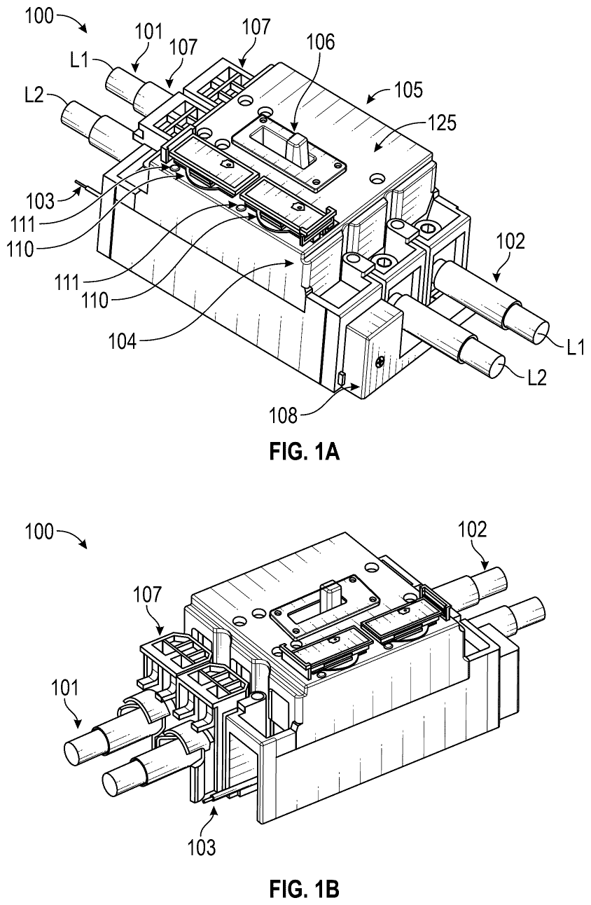

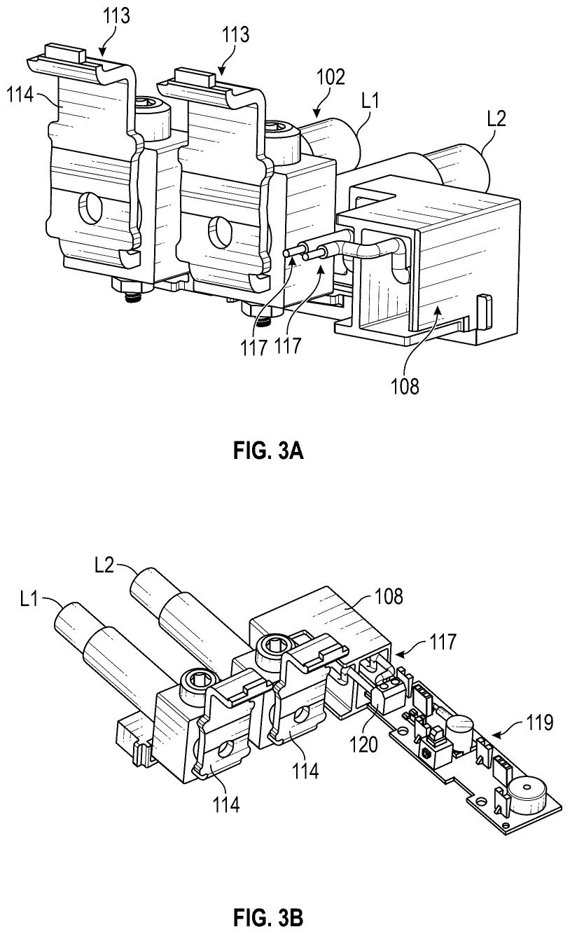

FIGS. 1A-9 show an innovative main circuit breaker 100 with integrated surge protection and its various aspects, in accordance with an example embodiment of the disclosed concept. The main circuit breaker 100 is referred to hereinafter as the “main breaker 100” for brevity. The main breaker 100 is structured to be connected to a utility customer's service entrance. The disclosed main breaker 100 represents an improvement over known main circuit breakers due to the integration of surge protection into the main breaker 100, in the form of a number of surge protection modules 110, eliminating the need to wire and install surge protection separately from the main breaker 100. That is, known main circuit breakers do not inherently include surge protection, thus requiring that a discrete surge protection device or scheme be separately installed.

Referring first to FIGS. 1A-1B, the main breaker 100 has a line side 101, a load side 102, and an earth ground wire 103, with a Line1 (L1) voltage connection and a Line2 (L2) voltage connection running from the line side 101 to the load side 102. The main breaker 100 comprises a main housing 104 that houses a main bus 105 (not visible in the figures), with the main bus 105 being structured to conduct and interrupt current between the line side 101 and the load side 102 of each of the Line1 and Line2 connections. The main breaker 100 includes a manual switch 106 that can be used to manually close the connections between the line side 101 and the load side 102, i.e. by turning the switch to an ON position, and to manually open the connections between the line side 101 and the load side 102, i.e. by turning the switch to an OFF position. The main breaker 100 is structured to enable finger protectors 107 to be coupled to the main housing 104. In the figures, the finger protectors 107 are only shown coupled to the line side, because residential service entrance main circuit breakers are typically labeled with a warning indicating that the main circuit breaker needs to be turned off and/or disconnected from power prior to being handled by a user, so finger protectors are often omitted from the load side 102.

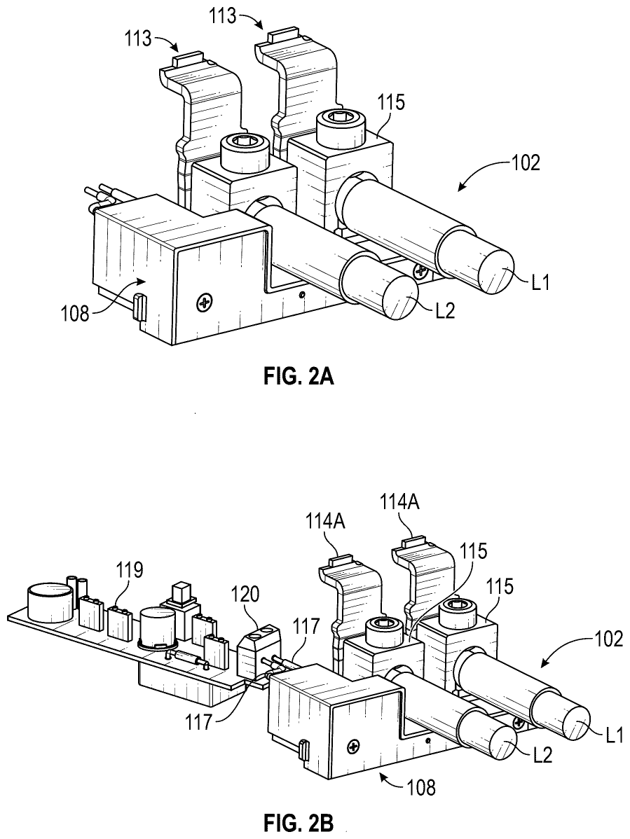

In addition to the main housing 104, the main breaker 100 comprises a surge bus housing 108 coupled to the main housing 104, detailed further in connection with FIGS. 2A-5C. The main breaker 100 further comprises a number of surge protection modules 110, which are coupled to the main housing 104 so as to extend from the interior of the main housing 104 to the exterior of the main housing 104. The specific iteration of the main breaker 100 shown in the figures includes two surge protection modules 110, one surge protection module 110 for the Line1 connection and one surge protection module 110 for the Line2 connection. The main breaker 100 further comprises a module status indicator 111 for each surge protection module 110. It is noted that, with known main circuit breakers that do not have integrated surge protection, dedicated surge protection has to be individually installed for each individual sub-feed. Another improvement that the main circuit breaker 100 provides over these known main circuit breakers is elimination of the need to install an individual surge protection scheme for each individual sub-feed, because the integrated surge protection provided by each surge protection module 110 to its connected line voltage path provides surge protection for any element connected to the load side 102 of that line voltage path of the main breaker 100.

The specific iteration of the main breaker 100 shown in the figures is designed for use in residential load centers in the U.S., which typically use a split-phase wiring configuration. However, it will be appreciated that the main breaker 100 can be adapted for use with a different wiring configuration, and to the extent that said different wiring configuration includes only one voltage connection or more than two voltage connections, the main breaker 100 can include a corresponding number of surge protection modules 110 so that each voltage connection has a dedicated surge protection module 110.

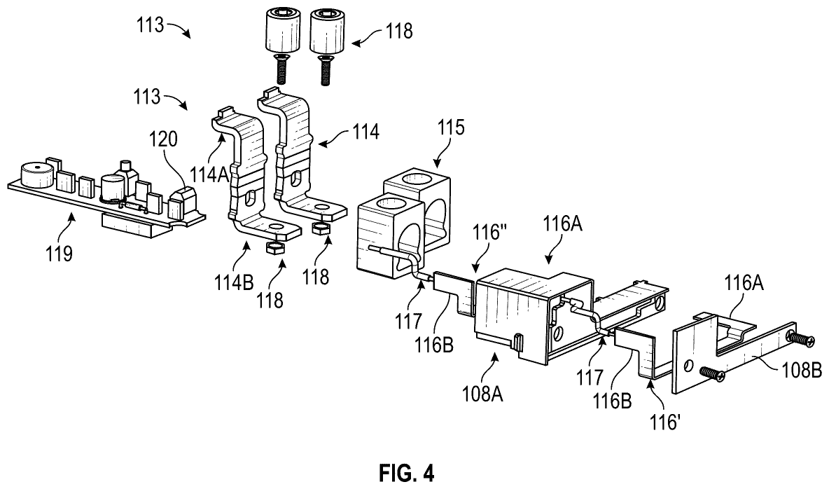

Referring to FIGS. 2A-4, the main breaker 100 further comprises a surge diversion arrangement 113 for each voltage connection, much of which is housed by the surge bus housing 108 and some of which is housed in the main housing 104. Each surge diversion arrangement 113 comprises a plurality of components that provide an electrical path between the load side 102 of each voltage connection and the corresponding surge protection module 110, with the individual components being easiest to discern in the exploded view shown in FIG. 4. Each surge diversion arrangement 113 includes a conductive bus bracket 114, a lug block 115, and a conductive load surge bus 116. In FIG. 4, the specific load surge bus 116 connected to Line1 is numbered 116′ and the specific load surge bus 116 connected to Line2 is numbered 116″, but the addition of the prime symbol (i.e.′) to the reference number 116 is solely for the purpose of being able to refer specifically Line1 or Line2, as needed. That is, both load surge buses 116′ and 116″ function in the same way, and either load surge bus 116′ or 116″ can be referred to generally using the reference number 116.

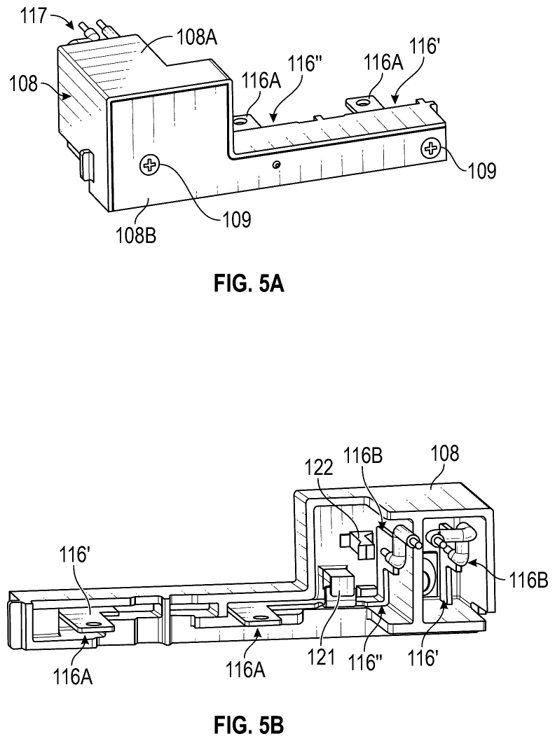

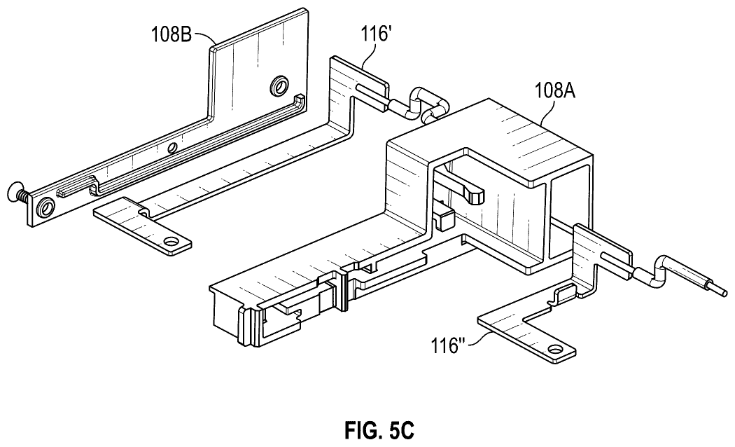

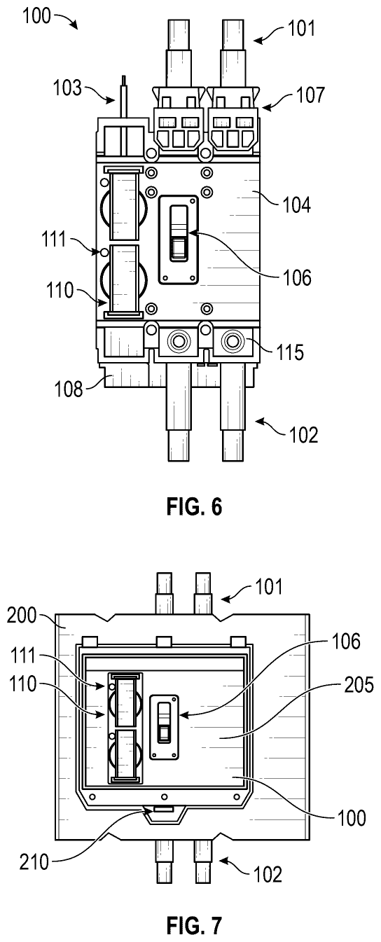

In each surge diversion arrangement 113, the load side 102 of the voltage connection is connected to the lug block 115 (as numbered in FIGS. 2A-2B and 6). The bus bracket 114 is structured to be coupled at a first end 114A to the main bus 105 (as previously noted, the main bus 105 is not visible in the figures), while a second end 114B is structured to be inserted into the lug block 115 (as best discerned in FIG. 4). A first end 116A of the load surge bus 116 is structured to be inserted into the lug block 115 so as to be in physical (and thus electrical) contact with the bus bracket second end 114B. The positional relationship between each lug block 115 and the first end 116A of each load surge bus 116 is most discernible when viewing FIG. 4 in conjunction with FIG. 5A, as FIG. 5A shows how each first end 116A extends outside of the surge bus housing 108. A jumper wire 117 is connected to a second end 116B of the load surge bus 116.

A number of lug fasteners 118 are used to secure the bus bracket second end 114B and the load surge bus first end 116A within the lug block 115. Said fastening components 118 can include, for example and without limitation, lug nuts and lug bolts. Each jumper wire 117 is connected to a printed circuit board assembly (PCBA) 119, and specifically, to a terminal block 120 (shown in FIGS. 2B, 3B, and 4) on the PCBA 119. The PCBA 119 is structured to enable the surge protection modules 110 to electrically connect to it, and for a given load surge bus 116 connected to the terminal block 120, the PCBA 119 is configured to transfer any surge from the given load surge bus 116 to a corresponding one of the surge protection modules 110.

Reference is now made to FIGS. 5A-5C, which show features of the surge bus housing 108. The surge bus housing 108 comprises a primary housing 108A and a housing back plate 108B that gets coupled to the primary housing 108A via fasteners such as mounting screws 109, for example and without limitation. It is noted that the mechanical connection between the primary housing 108A and the backplate 108B provided by the mounting screws 109 meets the UL requirements to be considered a sealed surface. In viewing FIGS. 5B and 5C, it can be seen that the primary housing 108A and the backplate 108B are each be designed to support and/or mount one of the load surge buses 116. For the specific iteration of the surge bus housing 108 shown in the figures, the primary housing 108A is structured to support the Line2 bus 116″ and the backplate 108B is structured to support the Line1 bus 116′. For example, as numbered in FIG. 5B, the primary housing 108A comprises a snap-behind holding feature 121 that facilitates a snap-fit coupling between the Line2 bus 116″ and the primary housing 108A. It is noted that the primary housing 108A further comprises a snap-on feature 122 that is structured to snap into engagement with the main housing 104 in order to properly align the surge bus housing 108 with the main housing 104 when the surge bus housing 108 and the main housing 104 are being coupled to one another.

The surge bus housing 108 and the main housing 104 are produced from electrically insulative material. The insulative material can be thermoplastic, for example and without limitation. Each surge diversion arrangement 113 must be physically and electrically isolated from the other surge diversion arrangement 113, in order to keep the Line1 and Line2 voltage connections electrically isolated. It will be appreciated from viewing FIGS. 5A-5C in conjunction with FIGS. 2A-4 that the surge bus housing 108 is structured to physically separate each surge diversion arrangement 113 from the other surge diversion arrangement 113 and is further structured to physically contain each surge diversion arrangement 113 within the interior of the main breaker 100. Due to the surge bus housing 108 being produced from electrically insulative material, each surge diversion arrangement 113 is also electrically isolated from the other surge diversion arrangement 113 and electrically insulated from the environment external to the main breaker 100, making the main breaker 100 compliant with applicable electrical codes such as UL 489. In particular, UL 489 requires there to be a minimum distance between live conductive elements of different voltage connections (i.e. Line1 and Line2), both over any surface of the main breaker 100 and through the air. The main breaker 100 is additionally designed to account for the fact that main circuit breakers are typically installed in steel structures, with the surge bus housing 108 being designed to ensure that the surge diversion arrangements 113 will be electrically isolated and insulated from the steel structure in which the main breaker 100 is likely be installed in.

When there is a surge in either the Line1 connection or the Line2 connection, the applicable bus 116′, 116″ carries the surge to the corresponding surge protection module 110. The surge protection modules 110 are connected to the earth ground wire 103, and the earth ground wire 103 transmits the surge to ground. Each surge protection module 110 can comprise any device suitable for mitigating the effects of a voltage surge, such as an MOV (metal oxide varistor), for example and without limitation.

Each surge protection module 110 and its corresponding module status indicator 111 are physically and electrically connected to a module monitoring circuit 125 connected to the PCBA 119 (the module monitoring circuit 125 not being shown separately in the figures but being indicated as contained within the main housing 104 in FIG. 1A). The module monitoring circuit 125 is configured to monitor the state of each surge protection module 110 and thus advantageously indicates to a user what the state of each surge protection module 110 is, via the module status indicator 111 corresponding to each surge protection module 110. The module status indicator 111 can comprise, for example and without limitation, an LED that lights up in different colors to indicate different stages of life of the corresponding surge protection module 110. Continuing to refer to this non-limiting example, the module status indicator 111 can comprise an LED configured to light up in a first color (e.g. green) when the surge protection module 110 is operating normally, configured to light up in a second color (e.g. yellow) when the surge protection module 110 has relatively limited useful life remaining, and configured to light up in a third color (e.g. red) when the surge protection module 110 is considered to be at or near the end of its useful life. It will be appreciated however, the module status indicator 111 can be configured to indicate the remaining useful life of the associated surge protection module 110 in other ways without departing from the scope of the disclosed concept, such as, for example and without limitation, by causing a light to blink or turn on/off, or via auditory signals.

FIG. 6 shows a front elevational view of the main breaker 100, and FIG. 7 shows a front elevational view of the main breaker 100 installed in a weather-safe enclosure 200, which includes a rain tight cover 205 and a loop and hasp arrangement 210 structured to enable a padlock to lock the rain tight cover 205. It is noted that rain tight covers are often transparent and that the rain tight cover 205 is depicted as transparent in FIG. 7. It is further noted that the main breaker 100 is structured to be installed in the weather-safe enclosure 200 so that the manual switch 106 and the surge protection modules 110 and corresponding module status indicators 111 are visible to a user, although other components of the main breaker 100 may be positioned underneath and covered by the housing of the weather-safe enclosure 200.

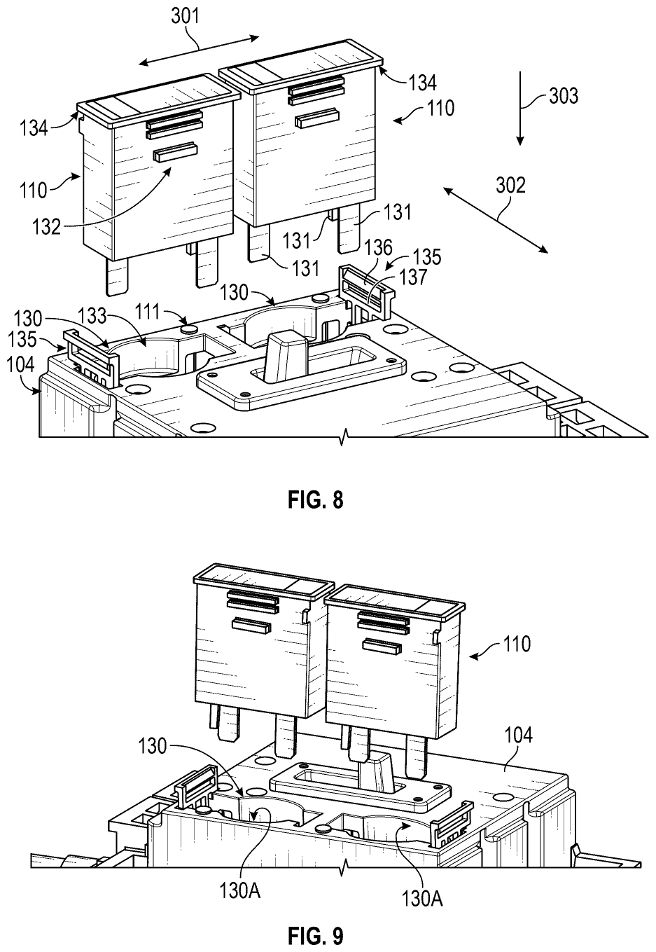

Reference is now made to FIG. 8 and FIG. 9 to discuss the advantageous features of the surge protection modules 110 integrated into the main breaker 100. The main housing 104 is formed with a module receiving opening 130 for each surge protection module 110. Each module receiving opening 130 is structured to receive a corresponding surge protection module 110 so that the surge protection module 110 can be received within the module receiving opening 130 and extend from the interior of the main housing 104 to the exterior of the main housing 104. As can be seen in FIGS. 8-9, each module receiving opening 130 is formed in the main housing 104 so as to produce two finger grip formations 130A (numbered in FIG. 9) in the main housing 104. When a surge protection module 110 is inserted into the opening 130, the two finger grip formations 130A are adjacent to two opposing sides of the surge protection module 110. The length of each finger grip formation 130A extends in a height dimension 301 (numbered in FIG. 8).

Each module receiving opening 130 is structured to enable the surge protection module 110 to be snugly inserted into the module receiving opening 130, while the finger grip formations 130A provide some clearance between two edges of the surge protection module 110 and the edge of the module receiving opening 130, so that a user can grip said two edges of the surge protection module 110 with their fingers (i.e. by inserting their fingers into the module receiving opening 130 between the edges of the module 110 and the finger grip formations 130A) and remove the surge protection module 110 as necessary solely using finger strength (i.e. without any tools). In particular, when one of the module status indicators 111 indicates that the corresponding surge protection module 110 needs to be replaced, a user can remove the installed surge protection module 110 from the main housing 104 solely using finger strength and insert a new surge protection module 110 into the main housing 104 solely using finger strength.

As labeled in FIG. 8, each surge protection module 110 comprises a number of stabs 131, and the module monitoring circuit 125 comprises corresponding jaws structured to receive the stabs 131 and electrically connect the stabs 131 to the terminal block 120 of the PCBA 119. In addition, each surge protection module 110 is formed with a positive stop 132 that is a protrusion structured to engage with a stop groove 133 (not visible in the figures) within the module receiving opening 130. The stop groove 133 in the module receiving opening 130 is structured such that, once the surge protection module 110 is inserted far enough into the module receiving opening 130 for the positive stop 132 to engage the stop groove 133, the surge protection module 110 is secured within the module receiving opening 130 and able to electrically connect with the module monitoring circuit 125 but cannot move any further into the module receiving opening 130.

Each surge protection module 110 is also formed with a ledge 134, and the main housing 104 is formed with a latch 135 for each module receiving opening 130, with each latch 135 being adjacent to the corresponding module receiving opening 130. The latch 135 is structured to engage with the ledge 134 of a surge protection module 110 being inserted into the module receiving opening 130 in order to secure the surge protection module 110 within the module receiving opening 130. The latch 135 extends in a width dimension 302 (numbered in FIG. 8) that is orthogonal to the height dimension 301.

Each latch 135 includes a sloped guiding surface 136 and a catch 137 at the bottom of the guiding surface 136. The sloped guiding surface 136 is the portion of the latch 135 that first engages the ledge 134 as the surge protection module 110 is moved in a downward direction 303 toward the interior of the module receiving opening 130 (the downward direction 303 being downward relative to the viewpoint shown in FIGS. 8 and 9). The downward direction 303 is orthogonal to both the height dimension 301 and the width dimension 302. The slope of the sloped guiding surface 136 exerts a pushing force against the ledge 134 in the height dimension 301 such that the ledge 134 is pushed slightly from its default position (the default position being the position assumed by the ledge 134 when no external forces are acting upon the ledge 134). The ledge 134 remains engaged with the sloped guiding surface 136 as the surge protection module 110 continues to be pushed downward. Once the surge protection module 110 moves far enough downward into the module receiving opening 130, the ledge 134 clears the guiding surface 136 in the downward direction 303, and the ledge 134 moves back to its default position and gets caught by the catch 137 in order to securely couple the ledge 134 to the latch 135, thereby securely coupling the surge protection module 110 to the main housing 104 within the module receiving opening 130.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A main circuit breaker structured to be connected to a service entrance, the main circuit breaker comprising:
a main housing;
a main bus having a line side and a load side, the main bus being housed within the main housing;
a number of voltage connections extending between the line side and the load side;
a surge diversion arrangement and a surge protection module for each voltage connection, the surge diversion arrangement electrically connecting the load side to the surge protection module; and
a ground wire,
wherein each surge protection module is electrically connected between the load side and the ground wire, and
wherein each surge protection module is coupled to the main housing.

2. The main circuit breaker of claim 1,
wherein each surge protection module comprises an MOV.

3. The main circuit breaker of claim 1,
wherein each surge protection module and the ground wire are configured to divert any surge from the load side to ground.

4. The main circuit breaker of claim 1,
wherein the main housing comprises a module receiving opening for each surge protection module,
wherein each module receiving opening is structured to couple a given one of the surge protection modules to the main housing, and
wherein each module receiving opening is structured to enable removal of the given one surge protection module from the module receiving opening and to allow a replacement surge protection module to be inserted into the module receiving opening.

5. The main circuit breaker of claim 4,
wherein each module receiving opening is formed in the main housing so as to produce two finger grip formations in the main housing, and
wherein each module receiving opening is structured such that, when one of the surge protection modules is inserted into the module receiving opening, a user can insert one or more fingers into the module receiving opening between an edge of the surge protection module and the fingers grip formation nearest said edge.

6. The main circuit breaker of claim 5,
wherein each module receiving opening is structured such that, when one of the surge protection modules is inserted into the module receiving opening, the two finger grip formations are adjacent to two opposing sides of the surge protection module.

7. The main circuit breaker of claim 4,
wherein each surge protection module is formed with a ledge,
wherein the main housing comprises, for each unique module receiving opening, a latch formed adjacent to the module receiving opening, the latch comprising:
a sloped guiding surface; and
a catch at the bottom of the guiding surface,
wherein the sloped guiding surface is structured such that, when a selected one of the surge protection modules is being inserted into the module receiving opening in a downward direction, the sloped guiding surface is the portion of the latch that first engages the ledge,
wherein the sloped guiding surface is structured to exert a pushing force against the ledge as the selected one surge protection module moves in the downward direction while being inserted into the module receiving opening, the pushing force being in a height dimension orthogonal to the downward direction and causing the ledge to be pushed out of its default position,
wherein the ledge and the sloped guiding surface are structured such that, when the selected one surge protection module moves far enough in the downward direction into the module receiving opening:
the ledge clears the sloped guiding surface, and
the ledge moves back to its default state and gets caught by the catch in order to couple the ledge to the latch and thereby couple the surge protection module to the main housing within the module receiving opening.

8. The main circuit breaker of claim 1, further comprising:
a PCBA electrically connected to the number of surge protection modules; and
a surge diversion arrangement for each voltage connection, each surge diversion arrangement including:
a conductive bus bracket;
a lug block;
a load surge bus; and
a jumper wire,
wherein, for a given one of the voltage connections:
the load side is connected to the lug block;
the bus bracket is coupled at a first end to the main bus,
a second end of the bus bracket is inserted into the lug block,
a first end of the load surge bus is inserted into the lug block and in electrical contact with the second end of the bus bracket, and
the jumper wire connects a second end of the load surge bus to the PCBA such that any surge from the load surge bus gets transferred to a corresponding one of the surge protection modules.

9. The main circuit breaker of claim 8, further comprising:
a surge bus housing, the surge bus housing being coupled to the main housing,
wherein a first portion of each surge diversion arrangement is housed within the surge bus housing and a second portion of each surge diversion arrangement is housed within the main housing,
wherein the surge bus housing forms a sealed surface under UL standards.

10. The main circuit breaker of claim 9,
wherein the surge bus housing mounts each surge diversion arrangement.

11. The main circuit breaker of claim 1, further comprising:
a module monitoring circuit; and
for each surge protection module, a module status indicator, the module status indicator being electrically connected to the module monitoring circuit,
wherein each surge monitoring module is electrically connected to the module monitoring circuit,
wherein the module monitoring circuit is configured to monitor each surge protection module, and
wherein each module status indicator is configured to indicate a status of its surge protection module.

12. The main circuit breaker of claim 11,
wherein the status of each surge protection module is one of: a normal status, a limited useful life remaining status, and an end of life status.

13. The main circuit breaker of claim 11,
wherein, for each surge protection module, the module status indicator is configured to provide a visual indication of the status of its surge protection module.

14. The main circuit breaker of claim 11,
wherein, for each surge protection module, the module status indicator is configured to provide an auditory indication of the status of its surge protection module.
